(19) United States
(12) Patent Application Publication
(10) Pub. No.: US 2022/0193918 A1
(43) Pub. Date: Jun. 23, 2022

(54) ROBOTICALLY MANIPULATED CONTAINER GRIPPER AND RELATED SYSTEMS AND METHODS

(71) Applicant: All Weigh Automation LLC, Mound, MN (US)

(72) Inventor: David Leslie Coon, Mound, MN (US)

(21) Appl. No.: 17/129,810

(22) Filed: Dec. 21, 2020

(51) Int. Cl. B25J 13/08; B25J 15/08; B25J 9/00; B25J 9/16

(52) U.S. Cl. CPC B25J 13/085; B25J 15/08; B25J 9/1687; B25J 9/1697; B25J 9/0093

(57) ABSTRACT

According to one embodiment, a gripper for a robotic arm for pick and place palletizing of a container of material is disclosed. The gripper can include a body, a plate and one or more load cells. The body can have a frame and one or more mechanisms to capture the container. The plate can have a mounting connection for coupling to a wrist of the robotic arm. The one or more load cells can couple the body to the plate. The one or more load cells can be configured to measure a weight of the container of material when captured by the one or more mechanisms of the body.

### TECHNICAL FIELD

This disclosure relates to robotic palletizing, and more particularly, to robotically implemented manipulation of net weight contained materials with a gripper and to systems and methods related thereto.

### BACKGROUND

Robots are increasingly used in industry in many different capacities. Manipulation of products, such as for the palletizing of product, is no exception. Use of robots has led to more rapid and accurate operation. Robots have also facilitated a reduction in bodily injuries to workers. These injuries can result of repetitive movements, which can be automated. However, use of robots and automation has also presented challenges.

Generally, palletizing refers to a process of constructing a stack of items organized as layers on a pallet. A pallet is a standard support and carrier structure used in shipping items. The pallet provides a support surface for receiving the items stacked for transport.

Robotic arms with end effectors (sometimes termed “grippers”) have been developed in the bagged material industry. These can be used to manipulate bags to form pallets of bagged material (e.g. wood pellets, salt, fertilizer, animal feed, grass seed, bird seed, rock, sand, etc.). This process, termed robotic pick and place palletizing, utilizes the programmable arm and gripper to pick and place the bag from a picking location such as on or adjacent a conveyor to the pallet that is under construction.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

This disclosure describes systems, methods and apparatuses related to various challenges in automating palletizing. For example, weighing bags of product to determine if the bag is of an acceptable weight is not trivial to automate with the key issues being accommodating both time and space this requires into the palletizing process. One technique for weighing the bag is to stop the bag on a weighing station of the conveyor system that transports bag to the robotic arm to take a weight measurement. This weighing technique, repeated for bag after bag, can add significant time and delay to the palletizing process. If performed prior to the conveyor, the weight obtained may not be accurate due to a leaking bag once the bag reaches the end of the conveyor.

Another technique has been developed that utilizes a dedicated motion scale. This motion scale must be built into the conveyor system that carries the bags to the robotic arm. This motion scale adds length to the conveyor system and comes at a high cost as it is generally custom built for the conveyor application.

The present inventor has realized a new apparatus, system and method of weighing a bagged product during manipulation of the product by the gripper of the robotic arm. The inventor has recognized that taking the bag weight at this location (after the end of the conveyor while being held by the robotic arm and gripper) does not significantly add to process time, can be performed accurately, and does not require additional conveyor length. Taking weight after the conveyor and just prior to palletizing also ensures a most accurate weight for the bag is obtained.

According to one embodiment, a vision system can be implemented in combination with the weighing system and method discussed previously. This vision system can be used in combination with the weighing system and method as further control criteria to pass or reject a bag. Criteria for passing or rejecting a bag based upon the vision system can be implemented during manipulation of the bag by the gripper on the robotic arm. This differs from current practice, which stops the conveyor to remove a bag identified as leaking by a vision system. Thus, the vision system of the present disclosure can be implemented without significantly adding to process time. Image processing supporting these control techniques can be achieved by high-speed image processing methods (e.g., neural networks) and can utilize machine learning for improved results.

The present disclosure also contemplates a data collection system, data transfer system, data storage system, etc. based upon one or more of the weighing system, the vision system, or the combination thereof. The collected data can include one or more of data regarding the weight of each bag passing through the system, image data, SKU, date and/or time, batch, or the like. The data collection and storage can be organized at an SKU level, a pallet level, a batch or run level, etc. as desired. This data can be used for periodically checking accuracy of the weighing system and/or the vision system and can be used for quality assurance purposes. Data on measured properties such as weight, image data, etc. can also be used for machine learning and/or in other algorithms for useful purposes (e.g., improved process times, improved accuracy of results, etc.).

The details of one or more examples of the disclosure are set forth in the accompanying drawings and the description below. Other features, objects, and advantages of the disclosure will be apparent from the description, drawings, and claims.

The disclosure herein includes but is not limited to the following illustrative Examples. Each example includes elements that are optional and can be configured in a different manner than is claimed.

Example 1 is a gripper for a robotic arm for pick and place palletizing of a container of material, comprising:

a body having a frame and one or more mechanisms to capture the container;

a plate having a mounting connection for coupling to a wrist of the robotic arm; and

one or more load cells coupling the body to the plate, wherein the one or more load cells are configured to measure a weight of the container of material when captured by the one or more mechanisms of the body.

Example 2 is the gripper for the robotic arm of Example 1, further comprising one or more spherical washers coupled between the one or more load cells and the plate.
Example 3 is the gripper for the robotic arm of any one of Examples 1-2, wherein the one or more load cells comprise four load cells, each one of the four load cells is coupled to the plate at or adjacent a respective one of one of four corners of the plate.
Example 4 is the gripper for the robotic arm of Example 3, wherein the four corners are formed as arms extending from a main body of the plate.
Example 5 is the gripper for the robotic arm of Example 4, wherein the weight of the container of material is determined by collectively summing the weight sensed by each of the four load cells.
Example 6 is the gripper for the robotic arm of any one of Examples 1-5, wherein the one or more mechanisms include a plurality of fingers, a plurality of decker plates and one or more clamp plates.
Example 7 is a system for pick and place palletizing of a container of material, comprising:

a conveyor configured to transport the container of material;

a robotic arm;

a gripper configured to capture the container of material, wherein the gripper is configured to be manipulated by the robotic arm to move the container of material from the conveyor:

a plate configured to be positioned between the robotic arm and the gripper; and

one or more load cells configured to measure a weight of the container of material when the container of material is captured by the gripper.

Example 8 is the system of Example 7, wherein the one or load cells are configured to be connected to both the plate and the gripper.
Example 9 is the system of any one of Examples 7-8, wherein the gripper includes a plurality of fingers, a plurality of decker plates and one or more clamp plates.
Example 10 is the system of any one of Examples 7-9, further comprising one or more spherical washers configured to couple to the one or more load cells.
Example 11 is the system of any one of Examples 7-10, further comprising a vision system configured to image the container of material.
Example 12 is the system of Example 11, further comprising a controller configured reject the container of material based upon if the vision system determines the container of material has a puncture and is leaking the material or if the weight of the container of material falls outside of a range of acceptable weight, whereby upon such determination, the controller causes the robotic arm to move to a reject location and the gripper to release the container of material at the reject location.
Example 13 is the system of any one of Examples 7-10, further comprising a controller configured to determine if the weight of the container of material falls within of range of acceptable weight.
Example 14 is the system of any one of Examples 7-13, further comprising a computer implemented data system configured to gather, transmit and store data indicative of at least the weight of the container of material.
Example 15 is a method for pick and place palletizing of a container containing a material, the method comprising:

providing a robotic arm positioned adjacent a conveyor,

manipulating a gripper coupled to the robotic arm to capture the container containing the material;

lifting the container of material from the conveyor with the gripper:

measuring a weight of the container of material while captured by the gripper and lifted from the conveyor; and

placing the container of material in a first location based upon if the weight is acceptable or placing the container of material in a second location based upon if the weight is unacceptable.

Example 16 is the method of Example 15, wherein measuring a weight of the container of material while captured by the gripper and lifted from the conveyor is performed by one or more load cells mounted to a plate positioned between the gripper and the robotic arm.
Example 17 is the method of Example 16, further comprising neutralizing lateral force caused by deflection of the plate.
Example 18 is the method of any one of Examples 15-17, further comprising:

imaging the container of material; and

determining, based on the imaging, if the container of material has a puncture and is leaking the material.

Example 19 is the method of Example 18, wherein placing the container of material in the second location is further based upon if the container of material is determined to have the puncture and is leaking the material.
Example 20 is the method of any one of Examples 15-19, further comprising collecting, transmitting and storing data indicative of at least the weight of the container of material.

### BRIEF DESCRIPTION OF DRAWINGS

FIGS. 1A-1E show a system and method for robotic pick and place palletizing of bags of material in accordance with one example of the present application.

FIG. 2 is a highly schematic diagram of a system that can be used for robotic pick and place palletizing of bags of material. in accordance with one example of the present application.

FIGS. 3A-3C show an example of a gripper (an end effector) from various perspectives in accordance with one example of the present application.

FIGS. 4A-4D show the gripper of FIGS. 3A-3C operating to capture a bag in accordance with one example of the present application.

FIGS. 5A-5D shows an exemplary plate and load cells that are part of the gripper of FIGS. 3A-4D from various perspectives, in accordance with one example of the present application.

FIGS. 6A and 6B illustrate spherical washers that can be employed with the gripper of FIGS. 3A-4D in accordance with one example of the present application.

FIG. 7 shows an exemplary flow diagram of a routine that can be employed with a method of robotically implemented pick and place palletizing in accordance with one example of the present application.

### DETAILED DESCRIPTION

Various apparatuses, techniques, systems and methods are disclosed herein to more rapidly weigh a bag of material. This is accomplished as the bag is being manipulated by a gripper coupled to a robotic arm. A further aspect can include the use of a vision system in combination with the weighing system. Another aspect can include a computer implemented data system configured to gather, transmit and/or store data indicative of at least the weight of the bag of material. The apparatuses, techniques, systems and methods can achieve more desirable results (i.e., more rapid processing, lower cost due to fewer leaking bags being palletized, etc.).

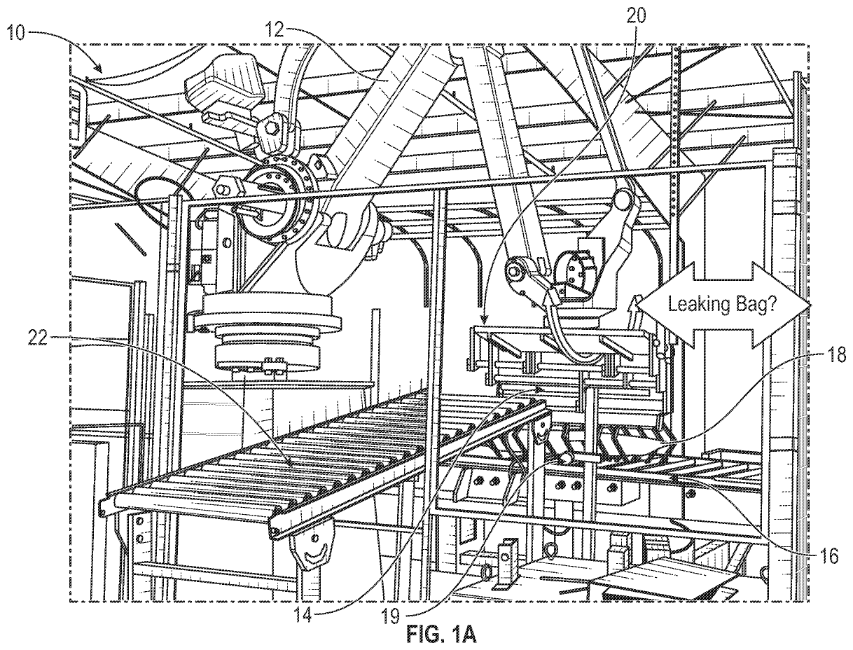

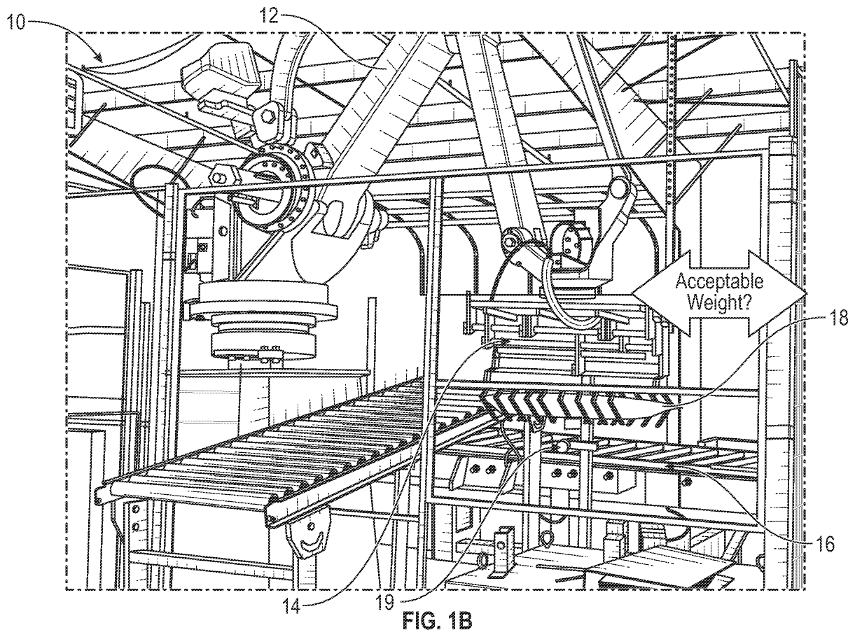

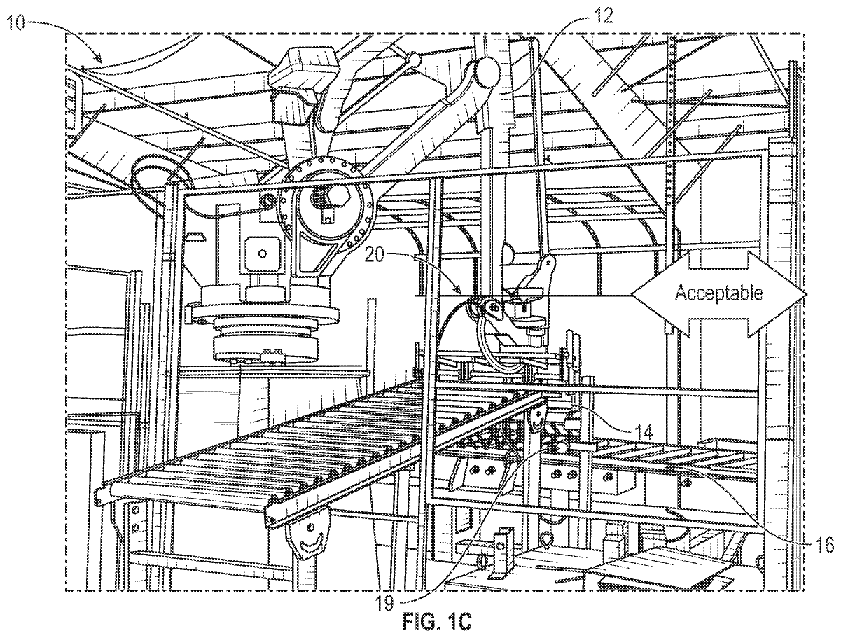

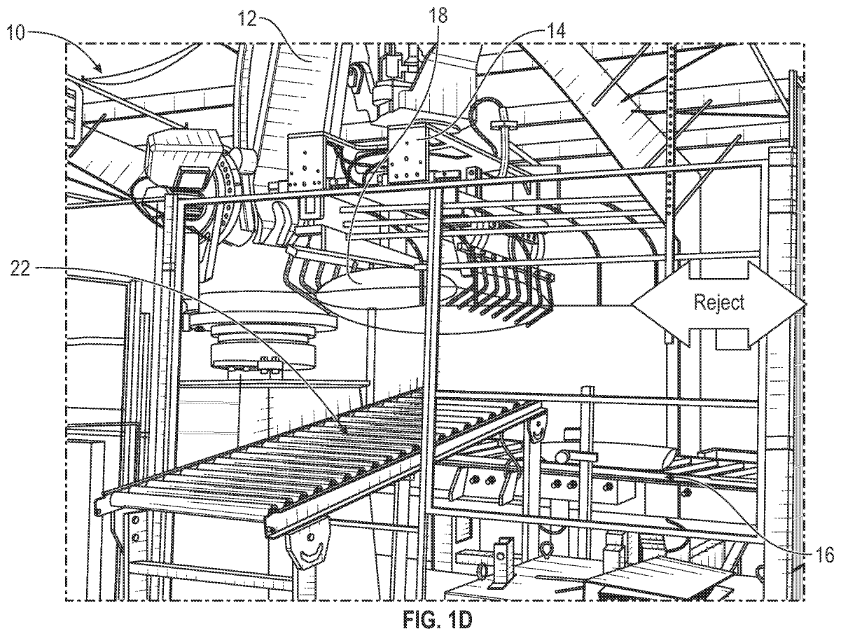

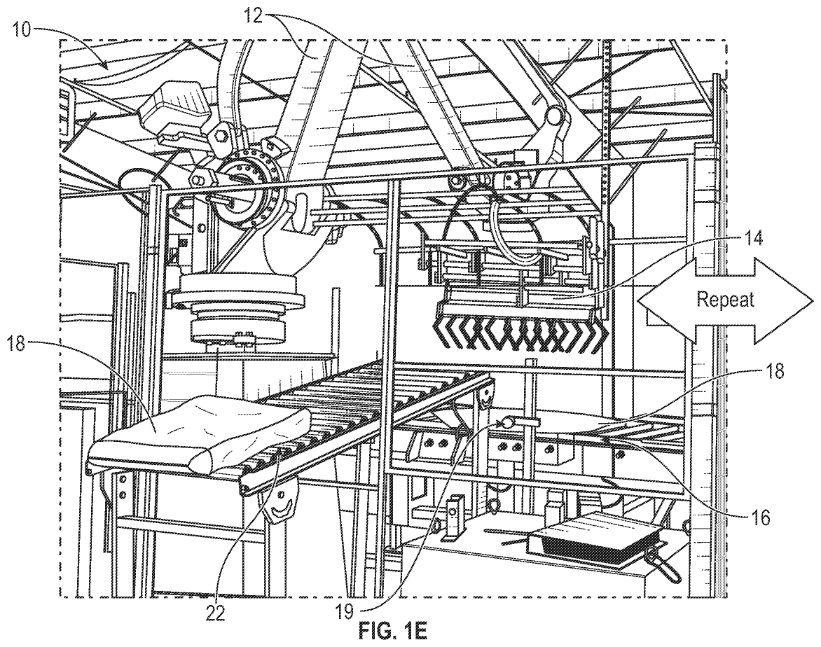

It should be understood that although an illustrative implementation of one or more embodiments are provided below, the disclosed systems and/or methods described with respect to FIGS. 1A-7 may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The disclosed techniques, systems and methods can include novel combinations of robotic methodology, apparatus combinations, sensing techniques, processing techniques, etc. that can result better results and the benefits as previously discussed. Computer implemented solutions (e.g., a controller such as part of the vision system) can include an optional learning component capable of optimizing provided process policy, continuously adapting the policy due to process variations or requirements, and/or learning the process policy from scratch with little-to-no human intervention.

As used herein the term “container” or variants thereof can include bags, or other net weight filled containers including pails, boxes and jugs. The term “bag” can include a specific container made of plastic, paper or the like. The bag can container a loose material as further discussed herein. Bags can be subject to puncture and leaking. Containers can hold a loose material in some examples. Thus, they could be subject to leaking but the likelihood of such occurrence is much more limited as compared with a bag. However, according to further examples, containers may contain any object(s) where achieving a net weight is desirable. It is understood that that present application provides examples directed to a bag in the illustrated embodiments but other containers such as pails, boxes and jugs that are net weight filled are also contemplated.

FIGS. 1A-1E show a system 10 for robotic pick and place palletizing of bags of material according to one embodiment. As shown in FIG. 1A, the system 10 can include a robotic arm 12, a gripper 14, a conveyor 16, one or more bags 18 of material, a pick location 19, a first drop location 20 and a second drop location 22. FIGS. 1A-1E also illustrate various potential process steps executed during the robotic pick and place palletizing of the bags 18 of material according to one embodiment.

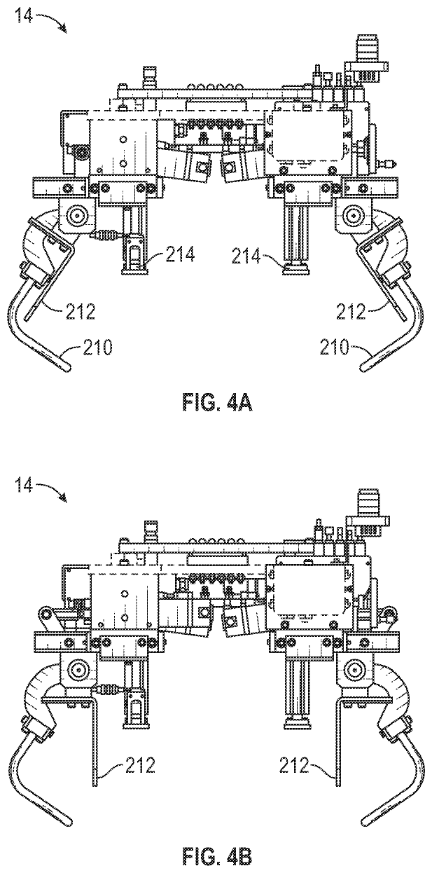

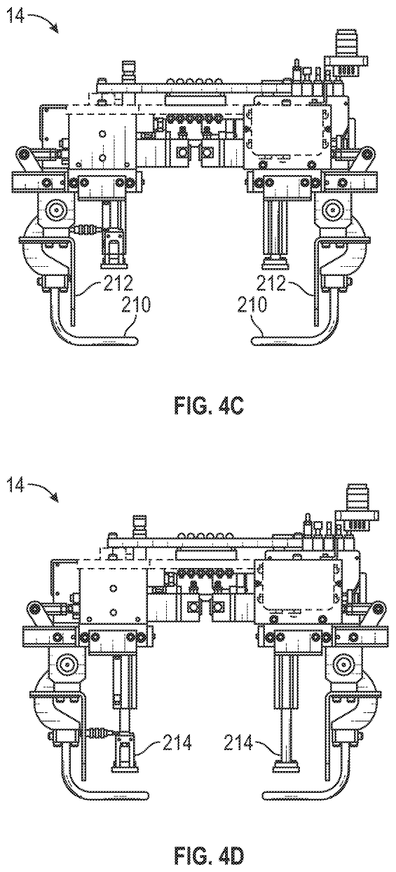

FIG. 1A shows the robotic arm 12 in the process of initially lowering and the gripper 14 being manipulated to capture the bag 18 at the pick location 19. Operation of the gripper 14 in opening and capturing the bag 18 will be discussed in reference to FIGS. 4A-4D subsequently.

As discussed previously, the bag 18 can contain a loose material (e.g., wood pellets, salt, fertilizer, animal feed, grass seed, bird seed, rock, sand, etc.). Thus, leaking of the bag 18 is undesirable. Furthermore, having the bag 18 within an ideal weight range is desirable. Underweight bags, leaking bags and/or overweight bags can cause orders to be rejected causing substantial time and monetary loss.

The pick location 19 can be positioned on or adjacent the conveyor 16, which transports the bag 18 to the picking location 19. A controller or other computer implemented device (discussed subsequently) can communicate with and operate the robotic arm 12 and the gripper 14 to control manipulation (e.g., capture, movement, etc.) of one or both of these items. The controller or other computer implemented device can also communicate with other system components (e.g., a load cell summing box, user interface, other controller(s), a vision system, data collection system, etc.) as further discussed herein. FIGS. 1A-1E shows a process whereby the robotic arm 12 and gripper 14 can operate according to a pre-programmed routine as further discussed herein.

According to one example, prior to, during or after the process illustrated in FIG. 1A, the controller or other device can query the vision system to determine if the bag 18 has a leak and should be rejected (i.e. moved to the second drop location 22). Indeed, such a query can be performed during or after the weighing step of FIG. 1B, for example. According to some examples, the controller itself rather than a controller of the vision system can make a determination if the bag 18 is leaking. If dropped in the second drop location 22 (sometimes termed a reject or recycle location) the bag 18 can be moved away to be opened and the material reprocessed (i.e. re-bagged), for example. This can be done by a second conveyor system as illustrated, for example.

FIG. 1B shows the robotic arm 12 manipulated to raise the bag 18 and the bag 18 captured by the gripper 14 from the picking location 19. Initially, the bag 18 can be raised above the pick location 19 only several inches to several feet such as illustrated in FIG. 1B. The robotic arm 12 can pause movement after this initial lift with the bag 18 captured by the gripper 14. During this pause, a weight measurement to determine the weight of the bag 18 can be performed as further discussed herein. The duration of this pause can be less than one second according to one embodiment. Indeed, it can be 0.5 seconds or less, 0.25 seconds or less, etc. according to further embodiments. Operation of the conveyor 16 need not be paused during the determination of the weight as this determination is done while the bag 18 is being gripped and lifted as illustrated in FIG. 1B.

As illustrated in FIG. 1B, the controller or other computer implemented device (discussed subsequently) can communicate with and operate the robotic arm 12 and the gripper 14 to control manipulation (e.g., facilitate initial lift of the bag 18, facilitate the pause, maintain capture, etc.) of one or both of these items. The controller or other computer implemented device can also communicate (query) with other system components such as a load cell summing box, one or more load cells, etc. to determine if the weight of the bag 18 is within an acceptable range. The acceptable range can vary depending on the product. For example, it can be within ±5% of a labeled weight on the package or another desired value.

In FIG. 1C, the weight of the bag 18 has been deemed acceptable by the controller (i.e. it is within the desired weight range). As a result, the robotic arm 12 is manipulated to be swung away from the pick location 19 to the first drop location 20. The gripper 14 can be manipulated to open at the first drop location 20. If a vision system is utilized, a further determination such as by the controller (or another system, another controller, etc.) has been made that the bag 18 is not leaking. The robotic arm 12 is operated according to a routine to drop the bag at the first drop location 20. This first drop location 20 can be directly onto a pallet, for example. The first drop location 20 can be onto an intermediate location such as another conveyor according to further examples.

FIG. 1D shows an example where either (or both) the weight of the bag 18 has been deemed unacceptable by the controller (i.e. it was not within the desired weight range) or a determination has been made that the bag 18 was leaking. As a result, the robotic arm 12 is manipulated to be swung away from the pick location 19 in a different direction from that of FIG. 1C to the second drop location 22. The gripper 14 can be manipulated to open at the second drop location 22. The robotic arm 12 is operated according to a routine to drop the bag at the second drop location 20. This second drop location 22 can onto a second conveyor (as shown) or onto the floor, a reject pallet, etc.

FIG. 1E illustrates the process of picking, weighing, determining, dropping can be operated rapidly. As shown, a rejected bag 18 can still be at the second drop location 22 while the robotic arm 12 and gripper 14 are already manipulated back to the pick location 19 and the picking process as described in FIG. 1A is being repeated.

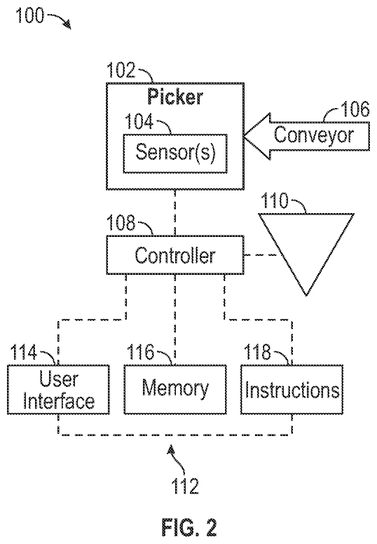

FIG. 2 is a highly schematic diagram of a system 100 that can be used for robotic pick and place palletizing of bags of material. The system 100 can include many of the components and aspects of the system 10 previously discussed but additionally illustrates and includes further components and aspects.

As shown in FIG. 2, the robotic arm 12 and the gripper 14 previously illustrated in FIGS. 1A-1E are referred to a picker 102. The picker 102 can be part of the system 100 that can additionally include sensor(s) 104, a conveyor 106, a controller 108, a vision system 110, a data system 112, a user interface 114, a memory 116 and instructions 118.

According to some examples, the memory 116, user interface 114, instructions 118 can be part of the data system 112, can be shared components or can be separate dedicated components. The controller 108 can be configured to operate and/or communicate with the user interface 114, the data system 112, the memory 116, etc.

As discussed previously, the picker 102 can include the sensor(s) 104 mounted aboard such as between the robotic arm 12 and gripper 14 as further discussed subsequently. The sensor(s) 104 can be configured to perform a weight measurement on a bag while the bag is being manipulated (e.g., held) by the picker 102 according to one embodiment. The sensor(s) 104 can be any type of sensor known for weight or force measurement, for example. However, other sensor(s) (e.g., accelerometer(s), gyroscope(s) and/or torque transducer(s)) measuring other criteria are also contemplated as part of sensor(s) 104.

The controller 108 can be configured to communicate electronically with various devices and systems utilized. The controller 108 may be spread over any number of controllers or can be a dedicated controller. The controller 108 may comprise one or more suitable electronic device(s)/server(s) capable of executing described functionality via hardware and/or software control. In some embodiments, the controller 108 may include one or more user interfaces (such as user interface 114), such as for displaying information and/or accepting instructions in the form on an input. The controller 108 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 108 can include one or more processors coupled to a memory device. The controller 108 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, controller may include operation control methods embodied in application code. These methods are embodied in computer instructions written to be executed by one or more processors, typically in the form of software. The software can be encoded in any suitable language, including, but not limited to, machine language, assembly language, and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 108 may be configured to execute computer program code instructions to perform aspects of various embodiments of the present invention described herein.

As discussed previously, the conveyor 106 can convey one or more bags 18 (FIGS. 1A-1E) to the picking location. The vision system 110 can be arranged along the conveyor 106, for example.

The vision system 110 can be configured in one or more manners. For example, according to one embodiment, the vision system 110 can employ an IR sensor, laser or other motion or light-based sensor device to detect leaked material falling between small gaps in the conveyor 106 line. If falling material is detected, the associated bag can be flagged and identified for rejection according to the process discussed previously in regard to FIGS. 1A-1E.

According to another example, the vision system 110 can use one or more high speed digital cameras mounted to above or to the side of the conveyor. Agitators can be employed along the conveyor to agitate bags to attempt to have material fall from the bag if a bag has a tear or puncture. This vision system 110 and can have a dedicated controller or can interact with and utilize controller 108 and can utilize a different imaging technique. For example, the vision system 110 can be configured with module or other software. This module can be configured to generate (or can be provided with one or more golden reference image(s) to be used by the vision system 110 for comparison. The golden reference image(s) can provide one or more examples of what a non-leaking sealed bag looks like. Additionally, the golden reference image(s) can provide one or more examples of what a leaking bag looks like. In some embodiments, the module may be configured to provide reference to the golden reference image to be used by the vision system 110 for comparison, such for use to check each bag for a leak. According to some examples, the vision system 110 can employ machine learning techniques to update golden reference image(s) to improve accuracy or results. Image processing supporting these control techniques can be achieved by any high-speed image processing methods (e.g., neural networks).

For example, the vision system 110 and/or the data system 112 can employ techniques that can take the place of the deterministic code previously residing in a robot controller or similar device and can provide the immediate real-time signals and processing for execution of the robotic arm. In this regard, the robotic arm can now serve a reactionary role in the system 100 driven by the vision system 110, controller 108, etc. The database of the system (e.g., the memory 116 can be cloud based) can serve as a long-term data repository that stores monitoring generated data of processing including variables, measurements, and resulting performance that can be correlated with identified operating parameter deviations and/or defects to generate instructions (sometimes termed policies) implemented by the controller 108. Additionally, the machine learning unit can be responsible for continuously improving the operating instructions based on observations (image data derived from monitoring) and subsequent reward (quality of performance). Online learning can be accomplished by a form of reinforcement learning such as Temporal Difference (TD) Learning. Deep Q Learning, Trust Region Policy Optimization, etc.

The data system 112 can be configured for data collection, data transfer and data storage. Thus, data from sensor(s) 104 process or unprocessed by controller can be supplied to the data system 112. Such data can be stored in memory 116, for example. Data transfer can be performed wirelessly or with wired connection.

The data system 112 can have dedicated components (e.g., a dedicated user interface 114, memory, instructions, controller, etc. However, some of these components can be shared between the different aspects of the system 110. As discussed, data can be based upon one or more of the weighing system, the vision system, or the combination thereof. The collected data can include one or more of data regarding the weight of each bag passing through the system, image data, or the like. This can data collection and storage can be organized at an SKU level, a pallet level, a batch or run level, etc. as desired. This data can be used for periodically checking accuracy of the weighing system and/or the vision system and can be used for quality assurance purposes. Data on measured properties such as weight, image data, etc. can also be used for machine learning and/or in other algorithms for useful purposes (e.g., improved process times, improved accuracy of results, etc.).

The memory 116 can be any suitable form of memory such as an EPROM (Erasable Programmable Read Only Memory) chip, a flash memory chip, a disk drive, or the like. As such, the memory may store various data, protocols, instructions, computer program code, operational parameters, etc. The user interface 114 and can include input devices such as touch pad, a keyboard, a mouse, a touchscreen and/or an output device such as a printer, a display screen, an audio device, and indicator light, etc. The user interface 114 can be configured to allow for communication with the controller 108 to provide and/or receive instructions.

The instructions 118 can be functions or algorithms (sometimes also referred to as routines). Instructions can be pre-programmed, can be machine learned, can be input from user interface 114 or another source, etc. The instructions 118 may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine. Modules described can include one or more dedicated controllers, memory, software and/or communication devices sufficient for implementation and interaction.

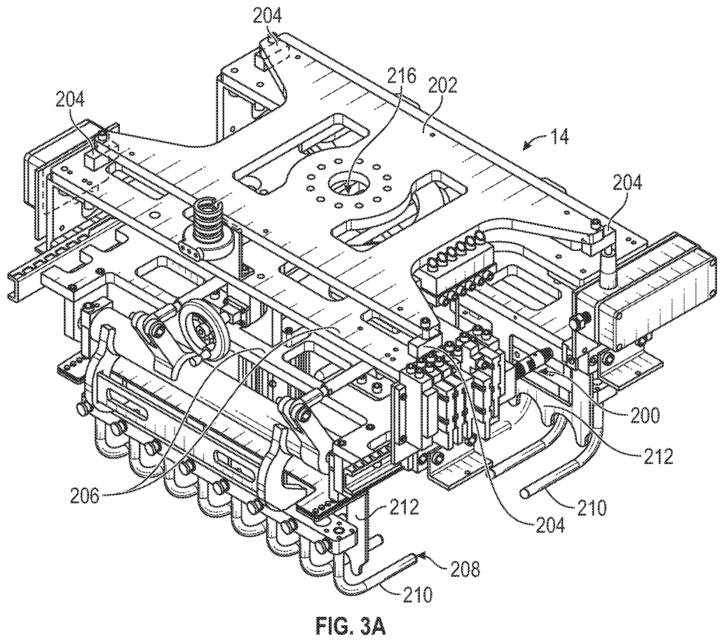

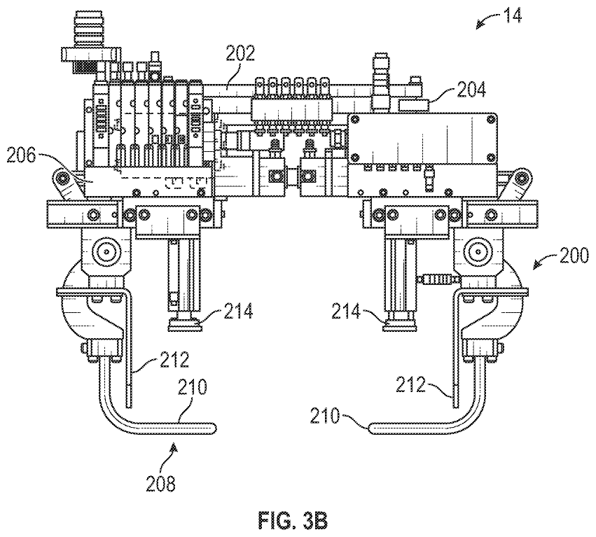

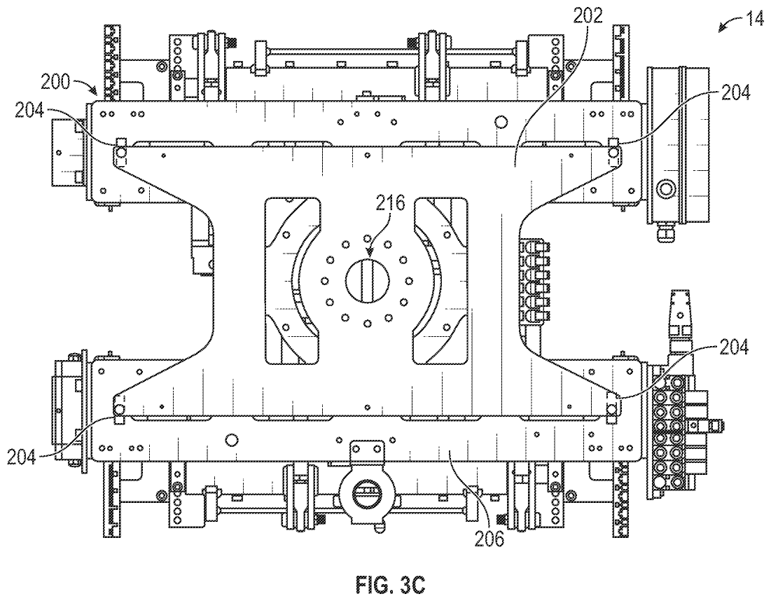

FIGS. 3A-3C show an example of the gripper 14. Other configurations of grippers are known in the art such that gripper 14 is illustrated for exemplary purposes. The gripper 14 can include a body 200, a plate 202 and one or more load cells 204. The body can have a frame 206 and one or more mechanism 208. The one or more mechanisms 208 can include a plurality of fingers 210, a plurality of decker plates 212 and one or more clamp plates 214 (only shown in FIG. 3B).

The gripper 14 can be mechanically, pneumatically or otherwise adjustable depending on the size of the bag being captured. As shown in FIGS. 3A and 3B, the plate 202 can be located between the body 200 and the robotic arm 12 (FIGS. 1A-1E). The plate 202 can be configured to couple with a wrist flange of the robotic arm 12, for example. Thus, the plate 202 can include a mounting connection 216 for couple with the robotic arm 12. This mounting connection 216 can include mounting holes to receive bolts or other fasteners, for example.

The plate 202 can be generally flat along opposing main body surfaces. The plate can be symmetrically shaped. Cutouts or other features can be utilized to reduce the weight of the plate, reduce defection of the plate when supporting the gripper and a bag, and/or to provide for passage or connection to features of the gripper below the plate 202.

The one or more load cells 204 can be mounted between the body 200 and the plate 202. Thus, the one or more load cells 204 can mechanically connect the body 200 to the plate 202 according to some examples. Fasteners such as nuts, bolts and washers (or other suitable fasteners) can be utilized to connect the load cells 204 with the plate 202 and body 200. The one or more load cells 204 can be configured to measure a weight of the bag of material when captured by the one or more mechanisms 210.

The load cells 204 can be tension bearing, and can be configured to measure tension force for example. However, compression load cells are also contemplated. The load cells 204 can comprise force transducers, for example. These can be configured with a low profile (2 inches or less, 1 inch or less, etc.) to minimize the length between the robotic arm 12 and the gripper 14. An example of a suitable load cell can comprise an SML low height S-type load cell manufactured by Interface Inc. of Scottsdale, Ariz. Such a load cell has a 0.75 inch height and operates to measure tension force. The load cells 204 can operate in a 0 to 20 mV range and can utilize a 10V excitation voltage for example.

FIGS. 3A-3C shows the one or more load cells arranged in a four-point loading scheme. The weight (here tension force) on each of the four load cells 204 can be summed at a load cell summing box (not shown), for example. The load cell summing box can be positioned of the gripper 14 and can communicate electronically therewith via wired or wireless connection. The summing of tension forces on the four load cells 204 can occur when the bag is held by the gripper 14 and paused in a position above the picking location as shown in FIG. 1B. Although a four-point loading scheme is illustrated, other loading schemes such as a three-point loading scheme are contemplated. Such different loading schemes would result in a different shape for the plate 202.

The frame 206 can comprise a stationary component relative the one or more mechanisms 208 such as the plurality of fingers 210, the plurality of decker plates 212 and the one or more clamp plates 214. The frame 206 can have openings to facilitate electrical, pneumatic, mechanical or other connections. The frame 206 can be formed of a metal or metal alloy designed to support loads including the weight of the bag, forces such a momentum, acceleration, etc. experienced when being manipulated by the robotic arm 12 (FIGS. 1A-1E).

FIGS. 4A-4D illustrate a process of closing the gripper 14 to capture a bag as was previously illustrated in FIGS. 1A-1E. The gripper 14 can be actuated (such as pneumatically or otherwise) to open to the position of FIG. 4A. In this position the plurality of fingers 210, the plurality of decker plates 212 and the one or more clamp plates 214 can all be in an open (first position).

FIG. 4B shows the decker plates 212 actuated to a closed position. This can help center the bag. FIG. 4C shows the fingers 210 moved to the closed position. Decker plates 212 can be retracted. This would position the fingers 210 under the bag. Fingers 210 can be configured to slip under the bag, such as by deforming the bag, without puncturing the bag. Thus, the tips of the fingers 210 are not provided with pointed or sharp ends, for example. The fingers 210 can comprise an array of spaced fingers formed of metal or metal alloy. The fingers 210 can be configured to support the weight of the bag in multiple locations.

FIG. 4D shows the one or more clamp plates 214 extended to a closed positioner where they would engage the bag and press against the opposing fingers 210.

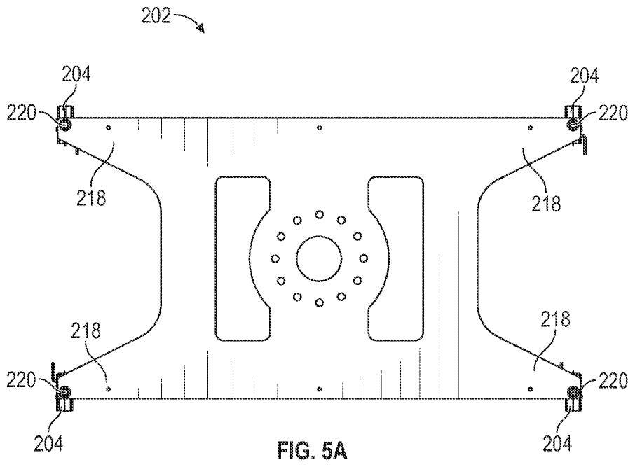

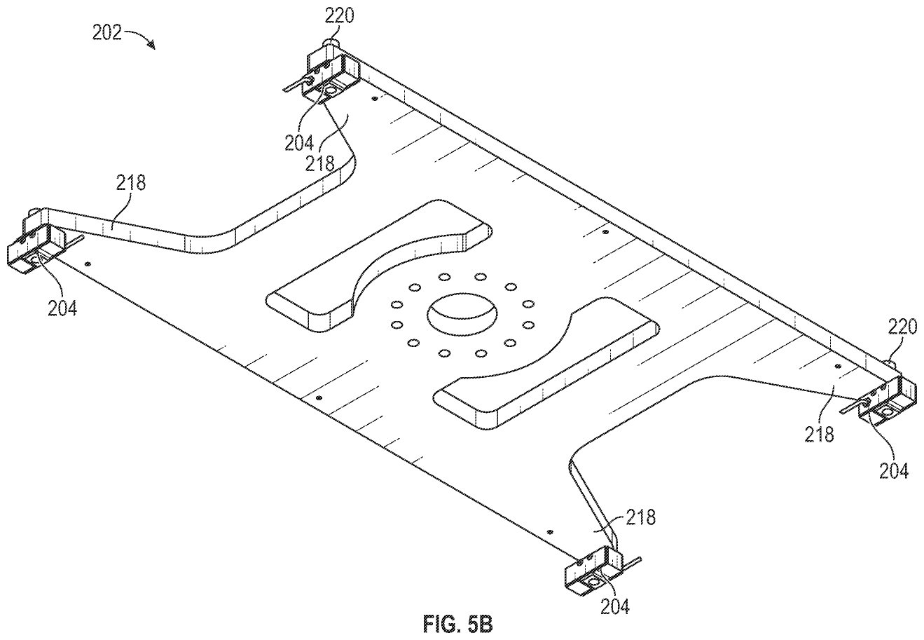

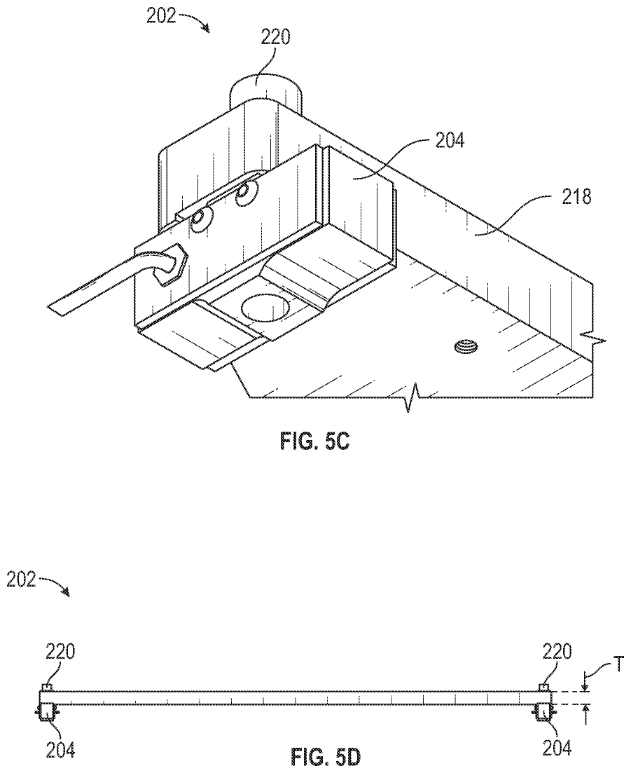

FIGS. 5A-5D show one configuration of the plate 202 and the one or more load cells 204 as previously described. As shown, fasteners can couple the one or more load cells to the arms 218. Each load cell 204 can be arranged adjacent or at a respective corner of the plate 202. As shown in FIG. 5C, each load cell can include a mounting feature (e.g. one or more apertures) configured to receive a fastener to mount to the body 200 as previously illustrated and described.

As shown in FIG. 5D, a thickness T of the plate 202 in the minor dimension can be selected as desired to minimize deflection of the plate 202 under load and considering other operational criteria. For example, the plate 202 can be 0.5 inches thick in the minor dimension according to some embodiments. However, in other embodiments with larger loading conditions, the plate 202 can be 0.75 inches thick in the minor dimension. Other thicknesses are contemplated. The plate 202 can be constructed of suitable materials that exhibit minimal deflection under load. Such materials can include metal or metal alloy. For example, stainless steel is contemplated.

The plate 202 can include arms 218 arranged to extend to four corners of the plate 202. These arms 218 can allow for access to the body 200 but can also be shaped to reduce or minimize deflection under loading. Ends of the arms 218 adjacent the corners include mounting features 220. These mounting features 220 can comprise apertures configured to receive a bolt or other fastener that attaches the one or more load cells 204 to the plate 202.

FIGS. 5A-5D show an exemplary configuration of the plate 202, further configurations such as those with arms 218 that fully cover the load cells 204 are also contemplated. Load cells 204 could also be recessed into apertures in the plate 202 to minimize the thickness profile of the combination of the plate 202 and load cells 204 according to some embodiments.

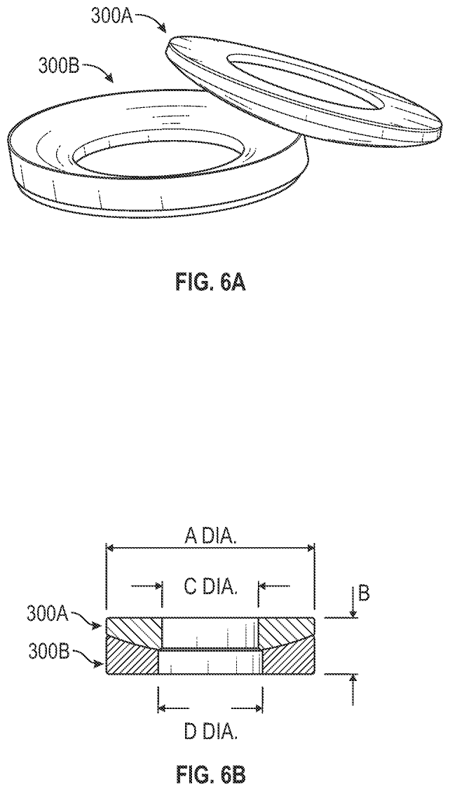

FIGS. 6A and 6B show spherical washers 300A and 300B that can be utilized with the mounting connection of the load cells 204 to the plate 202. The spherical washers 300A and 300B are designed to mount together as shown in FIG. 6B. The spherical washers 300A and 300B can be coupled to or configured to couple with fasteners that mount the load cells 204. The spherical washers 300A and 300B can be manufactured by Rice Lake Weighing Systems, for example. The dimensions of the spherical washers 300A and 300B can vary depending upon operating criteria such as the weight of the bags being manipulated and weighed. However, according to one example washers can be part number 15197 configured for a bolt size of 0.38 inches. Dimension A can be 0.88 inches. Dimension B can be 0.25 inches. Dimension C can be 0.41 inches. Dimension D can be 0.44 inches.

Spherical washers 300A and 300B can be designed to mount on one another as illustrated in FIG. 6B and can reduce or eliminate lateral forces on the mounting assembly of the plate 202 and load cells 204. These lateral forces can result from deflections of the plate 202 under load. Lateral forces, if too large, can cause an inaccurate measurement of the weight. Thus, spherical washers 300A and 300B can be employed to reduce or eliminate lateral forces on the load cells 204.

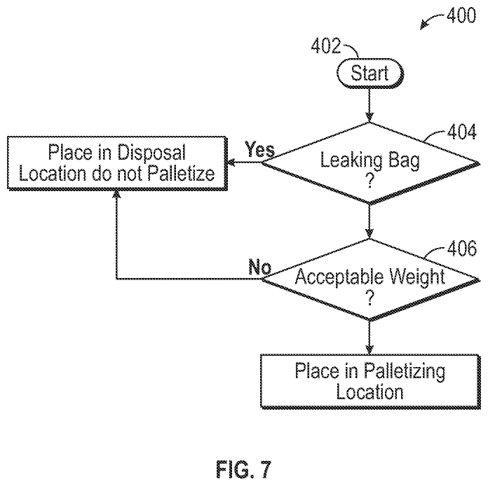

FIG. 7 shows an exemplary routine utilized by a method 400 for pick and place palletizing of a bag containing a material. The routine can proceed at a start 402. The method 400 can provide a robotic arm positioned adjacent a conveyor. The method 400 can include manipulating a gripper coupled to the robotic arm to capture the bag containing the material as previously illustrated and described. The method 400 can include lifting the bag of material from the conveyor with the gripper and measuring a weight of the bag of material while captured by the gripper and lifted from the conveyor. The routine shown in FIG. 7 can dictate operation of the robotic arm, gripper, etc. Thus, according to the routine, the method 400 can include placing the bag of material in a first location based upon if the weight is acceptable or placing the bag of material in a second location based upon if the weight is unacceptable.

The routine can proceed from a start 402. The routine can cause a first query 404 to a vision system to determine if the bag about to be or currently manipulated has been identified as a leaking bag. If the bag is a leaking bag, the bag is placed in a disposal location (i.e. the second location). Thus, according to the example of FIG. 7, placing the bag of material in the second location is further based upon if the bag of material is determined to have the puncture and is leaking the material. If the bag is not leaking, the routine proceeds to a second query 406 to determine if the measured weight falls within an acceptable range. If the weight is not acceptable, the bag is placed in a disposal location (i.e. the second location). If the measured weight is determined to be acceptable, the routine proceeds to indicate the bag should be placed in the first location (e.g., on a pallet).

The method 400 can utilize one or more load cells mounted to a plate positioned between the gripper and the robotic arm as previously described. Spherical washers such as those previously illustrated can be utilized in some cases to neutralize lateral force caused by deflection of the plate. The method 400 can utilize a vision system as described, thus, the method can include imaging the bag of material; and determining, based on the imaging, if the bag of material has a puncture and is leaking the material. The method 400 can further include collecting, transmitting and storing data indicative of at least the weight of the bag of material. Further data such as SKU, image data, date and time of processing, batch number, etc. can also be collected, transmitted and stored in addition to or in alternative to weight.

It is to be recognized that depending on the example, certain acts or events of any of the techniques described herein can be performed in a different sequence, can be added, merged, or left out altogether (e.g., not all described acts or events are necessary for the practice of the techniques). Moreover, in certain examples, acts or events can be performed concurrently, e.g., through multi-threaded processing, interrupt processing, or multiple processors, rather than sequentially.

In one or more examples, the functions described can be implemented in hardware, software, firmware, or any combination thereof, located locally or remotely. If implemented in software, the functions can be stored on or transmitted over a computer-readable medium as one or more instructions or code and executed by a hardware-based processing unit. Computer-readable media can include computer-readable storage media, which corresponds to a tangible medium such as data storage media, or communication media including any medium that facilitates transfer of a computer program from one place to another, e.g., according to a communication protocol. In this manner, computer-readable media generally can correspond to (1) tangible computer-readable storage media which is non-transitory or (2) a communication medium such as a signal or carrier wave. Data storage media can be any available media that can be accessed by one or more computers or one or more processors to retrieve instructions, code and/or data structures for implementation of the techniques described in this disclosure. A computer program product can include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair. DSL, or wireless technologies such as infrared, radio, and microwave are included in the definition of medium.

It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions can be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” or “controller” as used herein can refer to any of the foregoing structures or any other structure suitable for implementation of the techniques described herein. In addition, in some aspects, the functionality described herein can be provided within dedicated hardware and/or software modules. Also, the techniques could be fully implemented in one or more circuits or logic elements.

The techniques of this disclosure can be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units can be combined in a hardware unit or provided by a collection of interoperative hardware units, including one or more processors as described above, in conjunction with suitable software and/or firmware.

The functions, techniques, instructions or algorithms described herein may be implemented in software in one example. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the examples described are merely examples. The software may be executed on a digital signal processor, ASIC, microprocessor, or other type of processor operating on a computer system, such as a personal computer, server or other computer system, turning such computer system into a specifically programmed machine

Various examples/embodiments have been described. These and other examples are within the scope of the following claims.

What is claimed is:

1. A gripper for a robotic arm for pick and place palletizing of a container of material, comprising:
a body having a frame and one or more mechanisms to capture the container;
a plate having a mounting connection for coupling to a wrist of the robotic arm; and
one or more load cells coupling the body to the plate, wherein the one or more load cells are configured to measure a weight of the container of material when captured by the one or more mechanisms of the body.

2. The gripper for the robotic arm of claim 1, further comprising one or more spherical washers coupled between the one or more load cells and the plate.

3. The gripper for the robotic arm of claim 1, wherein the one or more load cells comprise four load cells, each one of the four load cells is coupled to the plate at or adjacent a respective one of one of four corners of the plate.

4. The gripper for the robotic arm of claim 3, wherein the four corners are formed as arms extending from a main body of the plate.

5. The gripper for the robotic arm of claim 4, wherein the weight of the container of material is determined by collectively summing the weight sensed by each of the four load cells.

6. The gripper for the robotic arm of claim 1, wherein the one or more mechanisms include a plurality of fingers, a plurality of decker plates and one or more clamp plates.

7. A system for pick and place palletizing of a container of material, comprising:
a conveyor configured to transport the container of material;
a robotic arm;
a gripper configured to capture the container of material, wherein the gripper is configured to be manipulated by the robotic arm to move the container of material from the conveyor;
a plate configured to be positioned between the robotic arm and the gripper; and
one or more load cells configured to measure a weight of the container of material when the container of material is captured by the gripper.

8. The system of claim 7, wherein the one or load cells are configured to be connected to both the plate and the gripper.

9. The system of claim 7, wherein the gripper includes a plurality of fingers, a plurality of decker plates and one or more clamp plates.

10. The system of claim 7, further comprising one or more spherical washers configured to couple to the one or more load cells.

11. The system of claim 7, further comprising a vision system configured to image the container of material.

12. The system of claim 11, further comprising a controller configured reject the container of material based upon if the vision system determines the container of material has a puncture and is leaking the material or if the weight of the container of material falls outside of a range of acceptable weight, whereby upon such determination, the controller causes the robotic arm to move to a reject location and the gripper to release the container of material at the reject location.

13. The system of claim 7, further comprising a controller configured to determine if the weight of the container of material falls within of range of acceptable weight.

14. The system of claim 7, further comprising a computer implemented data system configured to gather, transmit and store data indicative of at least the weight of the container of material.

15. A method for pick and place palletizing of a container containing a material, the method comprising:
providing a robotic arm positioned adjacent a conveyor,
manipulating a gripper coupled to the robotic arm to capture the container containing the material;
lifting the container of material from the conveyor with the gripper;
measuring a weight of the container of material while captured by the gripper and lifted from the conveyor; and
placing the container of material in a first location based upon if the weight is acceptable or placing the container of material in a second location based upon if the weight is unacceptable.

16. The method of claim 15, wherein measuring a weight of the container of material while captured by the gripper and lifted from the conveyor is performed by one or more load cells mounted to a plate positioned between the gripper and the robotic arm.

17. The method of claim 16, further comprising neutralizing lateral force caused by deflection of the plate.

18. The method of claim 15, further comprising:
imaging the container of material; and
determining, based on the imaging, if the container of material has a puncture and is leaking the material.

19. The method of claim 18, wherein placing the container of material in the second location is further based upon if the container of material is determined to have the puncture and is leaking the material.

20. The method of claim 15, further comprising collecting, transmitting and storing data indicative of at least the weight of the container of material.
